(19) United States
(12) Patent Application Publication
(10) Pub. No.: US 2016/0227882 A1
(43) Pub. Date: Aug. 11, 2016

(54) Knot Untier

(71) Applicant: Anthony Deluccia, New York City, NY (US)

(72) Inventor: Anthony Deluccia, New York City, NY (US)

(21) Appl. No.: 14/615,598

(22) Filed: Feb. 6, 2015

(51) Int. Cl. A43C 7/00; B25B 27/14; B65H 47/00

(52) U.S. Cl. CPC A43C 7/005; B65H 47/00; B25B 27/14

(57) ABSTRACT

This discloses a knot untier. The knot untier consists of an arm or pawl which is inserted into the knot to be untied plus, in some embodiments, a base which resembles a credit card. The knot untier in one embodiment is thus small enough to fit in a wallet. The knot untier may also be hung on a keychain. The knot untier does not, as many existing untiers do, damage most lines.

### CROSS-REFERENCE TO RELATED APPLICATIONS

This application is a Continuation-in-Part of that application filed Oct. 2, 2013 as Ser. No. 14/026,403. This application also claims the benefit of U.S. Provisional Application No. 61/727,994, filed Nov. 19, 2012, the entireties of both of which are incorporated herein by reference.

### FIELD OF THE INVENTION

The present invention relates generally to hand tools, and more particularly, relating to hand tools for untying knots.

### BACKGROUND OF THE INVENTION

Tying and untying knots is an everyday event for nearly all in the US and other countries. It can be as simple an event as untying the laces on a pair of shoes, untying a string on a package, or untying a necktie. Most of these knots are easy to untie. However, there are knots that would have challenged Alexander the Great when he was faced with the mythical Gordian Knot. Few of us can use Alexander's solution of cleaving the knot with a sword. Preserving the material of which the knot is made is important to us. If a child has had the laces on play shoes double-knotted, mothers want to preserve the laces. To make matters worse, the child may have gotten the laces wet and tightened the knots. A wet, double-knot on a child's shoelace can be difficult to untie with existing methods. Because it is difficult to make a child hold still for long as the knot is being untied, this knot untier will make quick work of the job. This will avoid a need to discipline the child for fidgeting or resisting.

Anyone who fishes regularly has had to untie the snarl, knot-ball, or “bird's nest” in fishing line which may occur, usually after a reel backlash. Speaker wires or computer wires or Christmas tree bulbs can be put in a box for storage. When the box is opened months later, it is as if the wires deliberately tied themselves together in order to make a simple job far more difficult. To use the wires again, the knots must be undone without damaging the wires.

A common solution to untying such knots, if the knots will not yield to efforts without tools, is to use a pointed implement, such as, an awl or marlinspike. A number of tools using such pointed elements have been patented. Many are so bulky they wind up in toolboxes where they are out of reach when a person needs them. They cannot be carried on a keychain or in a wallet or pocket.

Tools with sharp pointed ends have problems. In untying tight knots, the sharp pointed end is pushed between strands of the knot. The user must push upwards or somehow loosen the knot. Often, that means forcing against a strand, which forcing simply tightens the knot-ball at another point. Sometimes the sharp pointed element damages the strands. Monofilament is weakened substantially when damaged by a sharp implement. Under tension, such as, when there is a fish on the line, damaged monofilament line can break with predictable results, often loss of the fish and tackle.

What is needed is a way to loosen a strand and bring it out of the knot-ball easily with minimal or no risk to the line. Extensive experimentation has shown that the solution is greatly improved if the inserted element has a hook-like portion. Then, the loosened strand can be pulled as much as and as far as the user finds helpful in untying the knot.

Existing inventions tend to be bulky and cannot be easily carried in the pocket of a user's shirt or pants or in a wallet or purse. Some have multiple parts which may not be strong enough to help in loosening a knot of anything stronger than sewing thread.

There may also be knots that will yield better to being worked on by a tool with a gently tapered element rather than an element with a hook-like portion.

### SUMMARY OF THE INVENTION

In this disclosure, the singular includes the plural and vice versa.

In the preferred embodiment of the present invention there are two main parts. In this embodiment, one part comprises one or more arm parts, one of which is inserted between the strands of the knot-ball. In some embodiments, the arm part terminates in a hook-like part. The second part is a relatively flat, generally rectangular base part from which the arm part extends.

The hook-like part resembles the pawl of a ratchet-and-pawl mechanism. For convenience only, the hook-like part will be called “the pawl” in the remainder of this disclosure unless context would make using another term easier to comprehend. Further, a pawl is an end part of an arm part which end part is distal from the junction of an arm part with a base part.

The angle which the centerline of the pawl forms with the longitudinal centerline of the arm part varies from zero to one hundred thirty five degrees depending on the particular embodiment where a “centerline” is an imaginary line bisecting the arm part or other part.

The arm part and base part are two parts of the same tool. The two parts can be part of the same relatively flat plate of metal, plastic, or other solid material subjected to the same process of machining or stamping.

It is also possible to manufacturer the arm part and base part individually then join them, using a process such as welding, gluing, or fastening with screws or rivets or similar means.

In an alternate embodiment, the end of the arm part can have no hook-like portion. In this alternate embodiment, the arm part tapers to a rounded point.

In the preferred embodiment the two parts of the tool resemble a small credit card, about 1.3 by 2.0 inches along its sides. This similarity to a credit card has the other advantage that the knot untier can be carried in a wallet, pocket, or purse the same way a credit card can. In alternate embodiments, the knot untier may have one arm part or more than one arm parts.

If manufactured separately, the arm part has no base. The base assists the user in manipulating the knot untier so the arm part in this alternate embodiment can be made wide enough that the user can easily grasp the arm part. The arm part can be the blade of a jackknife or could be attached to a handle such as that on a screwdriver.

How large the arm part must be will depend on the size of the knot being untied. A separate arm part of proper size could be used as a marlinspike, a fid, or even a “commander” (a very large fid used on hawsers).

The knot untier in the preferred embodiment measures about 1.3 inches wide by about 2.0 inches long and about one-eighth of an inch thick. In the preferred embodiment the arm parts are about 1.2 inches long. The ratio of width to length is in a range from about 0.4 to 0.6 to 1 but can be different in different applications.

In further alternate embodiments, the knot untier may measure as much as ten inches or more long or the knot untier may be as little as less than one inch long. The particular size depends on the application. The widths in these alternate embodiments may measure five inches or more down to about one-half inch wide. The thickness can also vary depending on the material chosen. A knot untier made with stronger materials will permit less thickness. The larger embodiments might be useful for untying hawsers or wire cable. The smaller embodiments might be useful for untying knots in sewing thread.

One of the advantages of the present invention over existing knot untiers is that the present invention has no moving parts. Moving parts make an invention more complicated and, thus, more costly. Moving parts can snag. They can break and make the tool unusable.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a perspective view of the knot untier constructed in accordance with the principles of the present invention;

FIG. 2 is a top or bottom view of the knot untier.

FIG. 3 is an end view of the knot untier, showing the end with the pawls nearest.

FIG. 4 is an end view of the knot untier, showing the end furthest from the pawls.

FIG. 5 is a side view of either side of the knot untier.

FIG. 6 is a perspective view of an alternate embodiment of the knot untier where the arm part is shorter than the arm part shown in FIG. 1 and there is not pawl.

FIG. 7 is the same as FIG. 2 but with dashed lines to indicate the longitudinal centerline of the arm part, pawl, and angle between these parts.

### DETAILED DESCRIPTION OF THE INVENTION

In this description, references to “one embodiment” or “an embodiment” mean that the feature being referred to is included in at least one embodiment of the invention. Moreover, separate references to “one embodiment” in this description do not necessarily refer to the same embodiment. Illustrated embodiments are not mutually exclusive, unless so stated, and except as will be readily apparent to those of ordinary skill in the art. Thus, the invention may include any variety of combinations and/or integrations of the embodiments described herein.

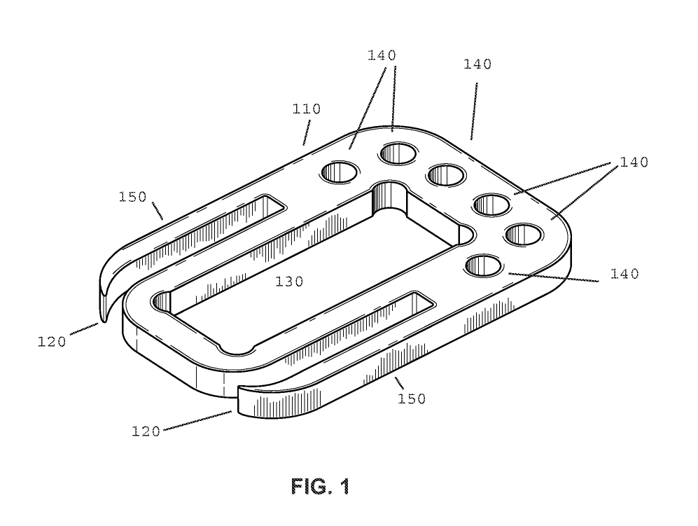

In FIG. 1, 110 is the base of the knot untier. As can be seen, in this embodiment, the knot untier is made from a relatively flat, generally rectangular, single solid piece, which solid can be metal, plastic, or other similar substance. 120 is the tip of the pawl. The tips have a rounded point to permit the user to insert the pawl between the strands in a knot-ball. The pawls curve inwards to permit the user to hook a loosened strand and pull the loosened strand from the knot-ball. In this embodiment, there are two arm parts 150 which here are the same. In other embodiments, the pawls may have curves and/or points that are different from one another. In other embodiments, the pawls may not curve but may be angular. The point may, in other embodiments, curve back toward the far end of the base in order to allow the pawl to hook a loosened strand. In some embodiments, there may be only one pawl. In some embodiments, there may be more than two pawls. In some embodiments, the pawls may have no curve at all.

130 in FIG. 1 is an open center section. When using the knot untier, an open center section allows the user to insert one or more fingers into the open section in order to get a good grip on the knot untier. The apertures 140 can serve any purpose the user wishes them to serve. If the user decides to attach the knot untier to a key chain, for example, the key chain can pass through one or more of the apertures. In this figure, there are six apertures. The number of apertures may, in alternate embodiments, vary from zero to as many as the manufacturer might wish to include.

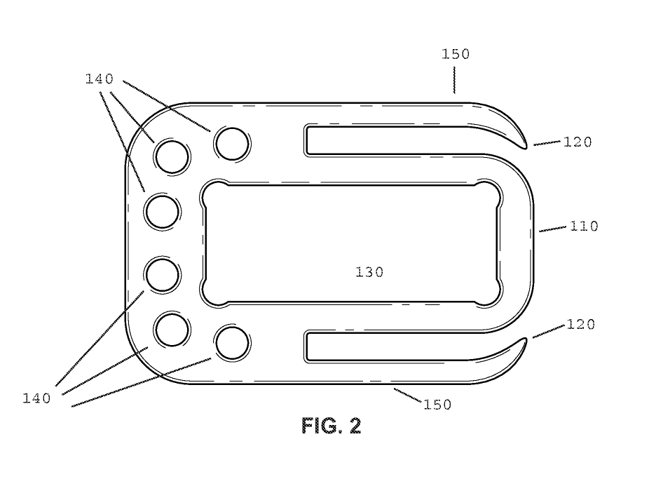

In FIG. 2, parts are the same as in FIG. 1.

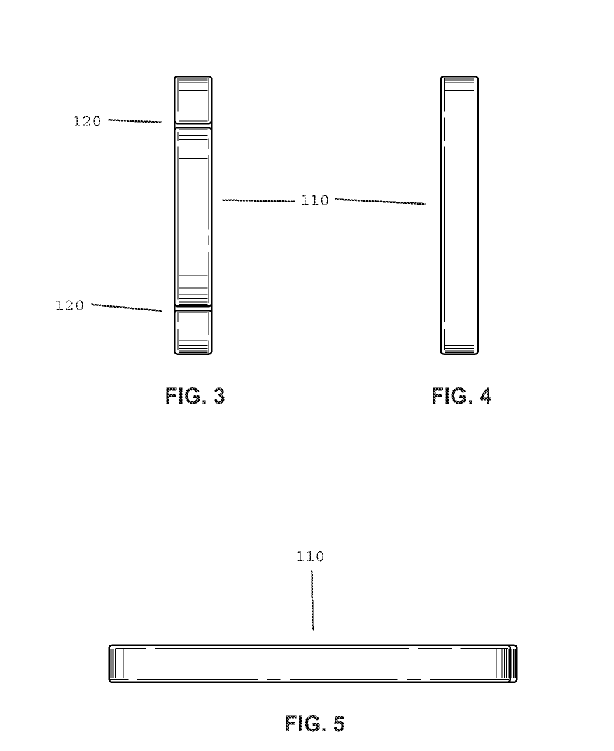

FIG. 3 shows the knot untier from the pawl end.

FIG. 4 shows the knot untier from the end opposite the pawl end. Tips of the pawls are 130. The base part is 110.

FIG. 5 shows the knot untier from a side. Base part is 110.

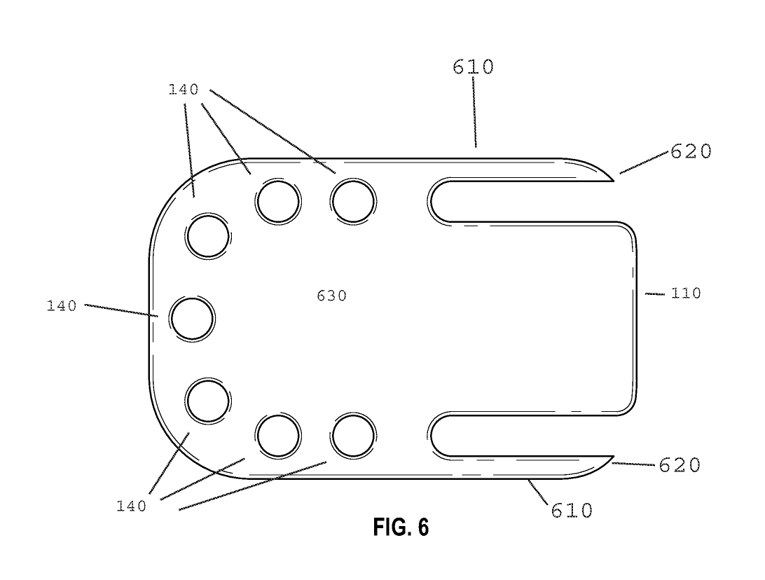

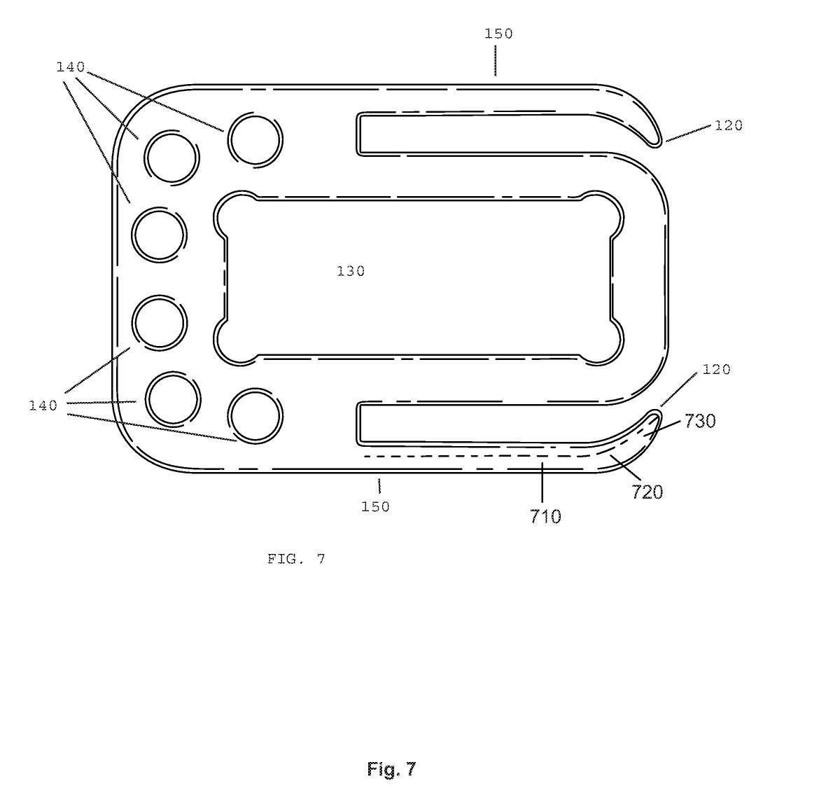

FIG. 6 shows an alternate embodiment of the knot untier. In this embodiment, there is no open center section 130. This makes it easier to affix names, team logos, advertizing, or other writings which writings may be on stickers or are glued or otherwise attached to the knot untier in the area where the open center section would be on the preferred embodiment. The closed center section is 630.

FIG. 6 shows another alternate embodiment. The arm parts 610 in this embodiment are shorter than the arm parts shown in FIGS. 1 and 2. In this particular embodiment, the arm parts are only 0.75 inches long. In larger or smaller embodiments of the knot untier, the arm parts can be proportionately larger or smaller as the application might require. Otherwise, the arm parts are the same as in other embodiments disclosed herein. The benefit of the shorter arm parts is that they are less likely than the longer arm parts to bend if subjected to greater tension. As a result, the knot untier with shorter arm parts can be made thinner or of different material than as in the preferred embodiment. The longer arm parts are useful for penetrating larger knot balls.

In the alternate embodiment shown in FIG. 6, the tips 620 of the arm parts do not have the hook-like tips as on the knot untier shown in FIGS. 1 and 2. The arm parts taper to rounded points which form the tips. This is simply another variant in the design of the knot untier. This alternate feature can be combined with other features to satisfy the particular application.

In FIG. 7, 710 indicates the location of the longitudinal centerline of the arm part. 730 indicates the location of the longitudinal centerline of the pawl. 720 indicates the location of the angle formed between the longitudinal centerline of the arm part and the longitudinal centerline of the pawl. These centerlines and the angle are not physical components of the hand tool. They are imaginary lines shown as dashed lines because they are for purposes of illustration only.

The elements of the alternate embodiments disclosed above, namely, a center section that is open or closed, shorter or longer arm parts, large or small bases, hook-like pawls or rounded tip pawls, and single or multiple arm parts that are the same or different from one another may be combined with one another in various combinations to form more alternate embodiments. The lengths, sizes, or tips of the arm parts on any base need not be identical to one another. For example, the shorter pawls may be combined with an open center section on yet another embodiment of the knot untier. An arm part with a straight tip may be combined with an arm part with a pawl with a ninety-degree angle with the centerline of the arm part. Thus, there exist a very large number of embodiments of the knot untier.

A number of embodiments of the present invention have been described. Nevertheless, it will be understood that various modifications may be made without departing from the spirit and scope of the invention. Accordingly, other embodiments are within the scope of the following claims.

I claim:

1-32. (canceled)

33. A hand tool for untying knots comprising a relatively flat, generally rectangular base part with one or more arm parts extending from a base part, with each arm part having a pawl at an end distal from where the arm part extends from the base part, with no part of any arm curving more than about 135 degrees, said hand tool having no sharp edges and having no sharp points.

34. The hand tool of claim 33 where said hand tool has no moving parts.

35. The hand tool of claim 33 with an open center section.

36. The hand tool of claim 33 with a closed center section.

37. The hand tool of claim 33 where sides of the rectangular base part are in a ratio of about 0.4-0.6 to 1.

38. A hand tool for untying knots comprising a relatively flat, generally rectangular base part with one or more arm parts extending from the base part, where each arm tapers to a point, with no part of any arm curving more than about 135 degrees, said hand tool having no sharp edges and having no sharp points.

39. The hand tool of claim 38 where said hand tool has no moving parts.

40. The hand tool of claim 39 with an open center section.

41. The hand tool of claim 39 with a closed center section.

42. The hand tool of claim 39 where sides of the rectangular base part are in a ratio of about 0.4-0.6 to 1.
